(19) United States
(12) Patent Application Publication
(10) Pub. No.: US 2006/0255734 A1
(43) Pub. Date: Nov. 16, 2006

(54) Plasma display panel

(76) Inventors: Tae-Ho Lee, Yongin (KR); Min-Sun Yoo, Yongin (KR)

Correspondence Address: LEE & MORSE, P.C., 3141 FAIRVIEW PARK DRIVE, SUITE 500, FALLS CHURCH, VA, 22042, US

(21) Appl. No.: 11/430,829

(22) Filed: May 10, 2006

(30) Foreign Application Priority Data
May 10, 2005 (KR) 10-2005-0038803

(51) Int. Cl. H01J 17/02

(52) U.S. Cl. 313/609

(57) ABSTRACT

A plasma display panel may include a first substrate and a second substrate arranged opposing each other, band-shaped first and second electrodes disposed between the first and second substrates and third electrodes disposed between the first and second substrates while extending in a first direction. Barrier ribs may be disposed between the first and second substrates. The barrier ribs may be spaced apart from each other in a second direction intersecting the first direction to define column spaces that extend in the first direction, the column spaces having wider portions and narrower portions alternately, the wider portions corresponding to discharge spaces. The first and second electrodes may cross the barrier ribs and protrude inside the discharge spaces such that the first and second electrodes form discharge gaps in each discharge space.

### BACKGROUND OF THE INVENTION

1. Field of the Invention

The present invention relates to a plasma display panel (PDP). More particularly, the present invention relates to a PDP in which a discharge time delay may be reduced by applying a discharge voltage required for discharge into a discharge space under favorable conditions and an operational margin may be increased by lowering the discharge voltage.

2. Description of the Related Art

In a PDP, in order to improve luminous efficiency (Im/W), defined as a ratio of visible light emission to power consumption, a ratio of an area of a sustain electrode and a scan electrode to an area of a discharge cell may be made as small as possible. A smaller area ratio improves luminous efficiency by reducing self-absorption of vacuum ultraviolet (VUV) light by a discharge gas. The self-absorption of VUV light may be reduced since discharge current decreases as the reactive power consumed for charging capacitance between a sustain electrode and a scan electrode decreases or the area ratio decreases.

However, when the widths of the sustain electrode and the scan electrode are narrowed in order to reduce the area ratio, the length of a surface discharge gap may increase. Thus, capacitance between the sustain electrode and the scan electrode may decrease, increasing the discharge firing voltage. Thus, a driving voltage margin may be reduced.

Increasing the number of discharge cells for a large-size and high definition screen may increase power consumption. While reduction of power consumption may be more important than heat reduction, both are required for a good quality product to realize operational margins required for stable display and to improve luminous efficiency.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention is therefore directed to a PDP, which substantially overcomes one or more of the problems due to the limitations and disadvantages of the related art.

It is therefore a feature of an embodiment of the present invention to provide a PDP in which the discharge time delay may be reduced by applying a discharge voltage required for discharge into a discharge space under favorable conditions.

It is therefore another feature of an embodiment of the present invention to provide a PDP in which the operational margin may be increased by lowering the discharge voltage.

At least one of the above and other features and advantages of the present invention may be realized by providing a PDP including a first substrate and a second substrate arranged opposing each other, band-shaped first and second electrodes disposed between the first and second substrates, third electrodes disposed between the first and second substrates while extending in a first direction, barrier ribs disposed between the first and second substrates, the barrier ribs being spaced apart from each other in a second direction intersecting the first direction to define column spaces that extend in the first direction, the column spaces having wider portions and narrower portions alternately, the wider portions corresponding to discharge spaces, and a phosphor in the discharge spaces, wherein the first and second electrodes cross the barrier ribs and protrude inside the discharge spaces such that the first and second electrodes form discharge gaps in each discharge space.

The first and second electrodes may extend in the second direction and may have bending portions protruding in the first direction in each of the discharge spaces. The first and second electrodes may have arc portions protruding in the first direction toward centers of the discharge spaces. The first and second electrodes may be arranged alternately along the first direction.

A distance between the first and second electrodes may increase as a distance from a center of the discharge space approaches a periphery of the discharge space.

The discharge gaps formed by the first electrodes and the second electrodes may form a row that intersects a column formed by the column spaces.

Each of the first and second electrodes may have arc portions protruding toward the centers of the discharge spaces and line portions connecting the arc portions in the second direction. The line portions may be wider than the arc portions. The line portions may be metal. The first and second electrodes are metal.

A pixel may include three adjacent discharge spaces, at least two of the three adjacent discharge spaces having centers shifted from one another in the first direction. Centers of the three adjacent discharge spaces may form a triangle.

The first and second electrodes may extend in the second direction and have a sinusoidal pattern.

Adjacent wider portions in the second direction correspond to every other third electrode.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a partially exploded perspective view of a plasma display panel according to a first exemplary embodiment of the present invention;

FIG. 2 illustrates a top plan view of a barrier rib structure of a plasma display panel according to the first exemplary embodiment of the present invention;

FIG. 3 illustrates a top plan view of a configuration and arrangement of barrier ribs and electrodes of a plasma display panel according to the first exemplary embodiment of the present invention; and

FIG. 4 illustrates a top plan view of a configuration and arrangement of barrier ribs and electrodes of a plasma display panel according to a second exemplary embodiment of the present invention.

### DETAILED DESCRIPTION OF THE INVENTION

Korean Patent Application No. 10-2005-0038803, filed on May 10, 2005, in the Korean Intellectual Property Office, and entitled: “Plasma Display Panel” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. It will also be understood that the term “phosphor” is intended to generally refer to a material that can generate visible light upon excitation by VUV light that impinges thereon, and is not intended be limited to materials the undergo light emission through any particular mechanism or over any particular time frame. Like reference numerals refer to like elements throughout.

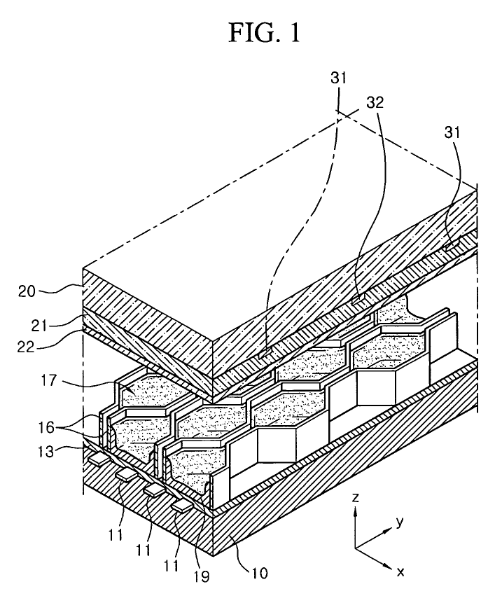

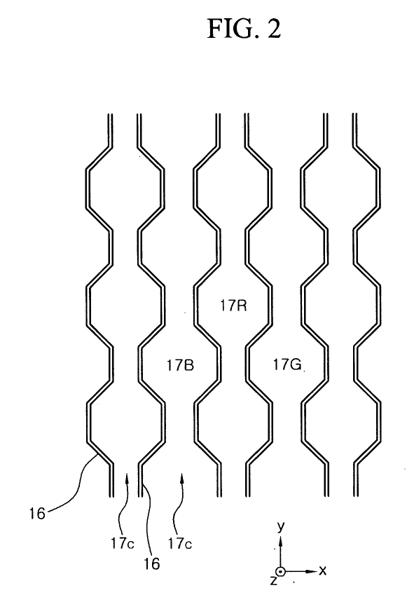

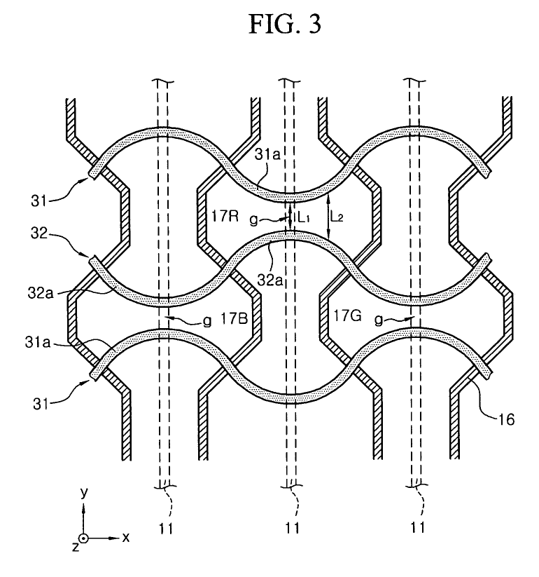

FIG. 1 illustrates a partially exploded perspective view of a plasma display panel (“PDP”) according to a first exemplary embodiment of the present invention, FIG. 2 illustrates a top plan view of a barrier rib structure, and FIG. 3 illustrates a top plan view of a configuration and arrangement of barrier ribs and electrodes of a PDP according to the first exemplary embodiment of the present invention.

As shown in FIGS. 1-3, the PDP may include a first substrate 10 (hereinafter, referred to as “rear substrate”) and a second substrate 20 (hereinafter, referred to as “front substrate”) arranged opposing each other with a predetermined gap therebetween. Barrier ribs 16 may be formed between the rear substrate 10 and the front substrate 20. The barrier ribs 16 may define a plurality of discharge spaces 17 between the rear substrate 10 and the front substrate 20. A phosphor layer 19 may be formed in the discharge spaces 17 and a discharge gas, e.g., a mixture of neon (Ne) and xenon (Xe), may fill the discharge spaces 17. The discharge gas may generate vacuum ultraviolet (VUV) light through plasma discharge. The phosphor layer 19 may absorb the VUV light and then emit visible light.

The PDP of this embodiment may include first electrodes 31 (hereinafter, referred to as usustain electrodes) and second electrodes 32 (hereinafter, referred to as “scan electrodes”) corresponding to each discharge space 17, and may include third electrodes 11 (hereinafter, referred to as “address electrodes”). These electrodes may generate VUV light through plasma discharge. The VUV light may then collide with the phosphor layer 19 such that images may be realized.

The address electrodes 11 may be formed on the inner surface of the substrate 10 and may extend along a first direction (y-axis direction in FIG. 1). When the address electrodes 11 are formed on the rear substrate 10, they may be of an opaque metal having excellent electrical conductivity, e.g., metal, since visible light need not pass therethrough.

The address electrodes 11 may continually correspond to a series of discharge spaces 17 neighboring with each other in the first direction. Each of the pairs of sustain and scan electrodes 31, 32 may be disposed to correspond to respective discharge spaces 17 neighboring with each other in a second direction (x-axis direction in FIG. 1) intersecting the first direction.

The address electrodes 11 may be covered by a first dielectric layer 13. The first dielectric layer 13 may protect the address electrodes 11 from damage by preventing ions or electrons from colliding directly with the address electrodes 11 at the time of discharge. The first dielectric layer 13 may be formed from dielectric material on which wall charges can be formed and accumulated.

The barrier ribs 16 may be formed on the first dielectric layer 13 between neighboring address electrodes 11 and extending in the first direction (y-axis direction in FIG. 2). The neighboring barrier ribs 16 may be spaced apart from each other in the second direction (x-axis direction in FIG. 2) such that the barrier ribs 16 define a plurality of column spaces 17c extending in the first direction (y-axis direction in FIG. 2).

Each column space 17c may enlarge periodically along the first direction. In other words, the barrier ribs 16 may bend in the second direction periodically while opposing each other along the first direction such that the column spaces 17c have wider portions and narrower portions alternately disposed along the first direction. Alternatively or additionally, the neighboring column spaces 17c may also form the wider portions and the narrower portions alternately disposed along the second direction.

The wider portions of the column space 17c may be used as discharge spaces 17. A series of discharge spaces 17 disposed along the second direction alternately correspond to the pairs of sustain and scan electrodes 31, 32 continually arranged along the second direction.

The discharge spaces 17 may form subpixels emitting visible light of one among red R, green G, and blue B colors. Three neighboring subpixels forming one pixel, i.e., three discharge spaces 17R, 17G, and 17B, may form a triangular pattern as shown in FIG. 2, as the discharge space 17 may alternately correspond to a pair of the electrodes 31, 32 neighboring each other along the first direction and may alternately correspond to the address electrodes 11 disposed continually along the second direction.

The phosphor layer 19 may include phosphor layers 19R, 19G and 19B corresponding to the colors of the discharge spaces 17R, 17G and 17B. The phosphor layer 19 may be coated on the inner surface of the barrier ribs 16 defining the discharge spaces 17 and the inner surface of the first dielectric layer 13. Each phosphor layer 19R, 19G and 19B, with phosphors excited by the VUV light generated at the time of plasma discharge, may emit red R, green G and blue B light, respectively.

The sustain electrodes 31 and the scan electrodes 32 may be formed on the inner surface of the front substrate 20 to construct a surface discharge structure corresponding to the discharge spaces 17 in order to produce plasma discharge in the discharge spaces 17, the inner surface of the front substrate 20 opposing the rear substrate 10.

The sustain electrodes 31 and the scan electrodes 32 may be formed of band-shaped electrodes that intersect the barrier ribs 16 defining the discharge spaces 17, and may protrude inside the discharge spaces 17, while forming discharge gaps g in centers of the discharge spaces 17. In other words, the discharge gaps g formed by the sustain electrodes 31 and the scan electrodes 32 may be formed along the second direction. Therefore, the direction along which the discharge gaps are formed may intersect with the direction along which the column spaces 17c are formed, i.e., the first direction.

The sustain electrodes 31 and the scan electrodes 32 may be formed of materials having high electrical conductivity, e.g., metal. Using electrodes having lower electrical resistances may decrease time from when a voltage is applied to the sustain electrodes 31 and the scan electrodes 32 to when discharge takes place in the discharge spaces 17. Thus, the discharge time delay may be decreased and a high operational margin may be obtained because the discharge voltage required for discharge is lowered. Thus, the sustain electrodes 31 and the scan electrodes 32 may apply the voltage required for discharge into the discharge spaces 17 under favorable conditions.

Moreover, the sustain electrodes 31 and the scan electrodes 32 may be respectively formed as a singular, band-shaped body. This may prevent increase of electrical resistance that may otherwise be generated at the contact portions of electrodes when formed of two or more materials having different electrical conductivities.

A scan pulse and an address pulse that may be applied respectively to the scan electrodes 32 and the address electrodes 11 may produce address discharge in select discharge spaces 17 to be turned on. Also, sustain pulses may be applied alternately to the scan electrodes 32 and the sustain electrodes 31 to produce sustain discharge in the discharge spaces 17 selected through the address discharge to display images.

The address electrodes 11, the sustain electrodes 31 and the scan electrodes 32 may perform other functions in accordance with the signal voltage applied to each electrode. Therefore the relationship between the electrodes and the signal voltages need not be restricted to the above relationship.

The sustain electrodes 31 and the scan electrodes 32 may extend along the second direction, which intersects with the address electrode 11, and include bending portions at each discharge space 17. The bending portions may protrude in the first direction. In other words, the sustain electrodes 31 and the scan electrodes 32 may have arc portions 31a and 32a at each discharge space 17. The arc portions 31a, 32a may protrude in the first direction toward centers of the discharge spaces 17.

The sustain electrodes 31 and the scan electrodes 32 may be arranged alternately along the first direction, corresponding to the column spaces 17c. The sustain electrodes 31 and the scan electrodes 32 may be symmetrical to each other along an axis of symmetry passing through the centers of the discharge spaces 17. The arc portions 31a and 32a of the electrodes may be disposed to have the shortest distance in the discharge spaces 17. Accordingly, the arc portions 31a and 32a of the sustain electrodes 31 and the scan electrodes 32 may form discharge gaps g at centers of the discharge spaces 17. Discharge gaps g may correspond to each of the subpixels 17R, 17G and 17B arranged in a triangular pattern.

The arc portions 31a and 32a of the sustain electrodes 31 and the scan electrodes 32 may form discharge gaps g at centers of the discharge spaces 17. Thus, the gaps between the sustain and scan electrodes may increase as a distance from a center of a discharge space 17 increases to the periphery of the discharge space 17. As shown in FIG. 3, a gap distance L1 at the center of a discharge space 17 may be shorter than a gap distance L2 located at any point away from the center.

The gap distance L1 at the center of each discharge space 17 may be short enough so that initial discharge can be induced by the short gap thereby lowering the discharge firing voltage. As the gap distance L2 increases towards the periphery of the discharge spaces 17, an excitation area of the phosphor layer 19 can be increased, thus improving luminous efficiency.

The sustain electrodes 31 and the scan electrodes 32 may be covered with a second dielectric layer 21. The second dielectric layer 21 may protect the sustain electrodes 31 and the scan electrodes 32 against the plasma discharge, and may lower the discharge firing voltage by forming and accumulating wall charges during the time of the sustain discharge. The second dielectric layer 21 may be covered with a protective layer 22. The protective layer 22 may protect the second dielectric layer 21, and may be a MgO protective layer transmitting visible light to promote the transmittance of the visible light through the front substrate 20 and to improve the secondary electron emission coefficient.

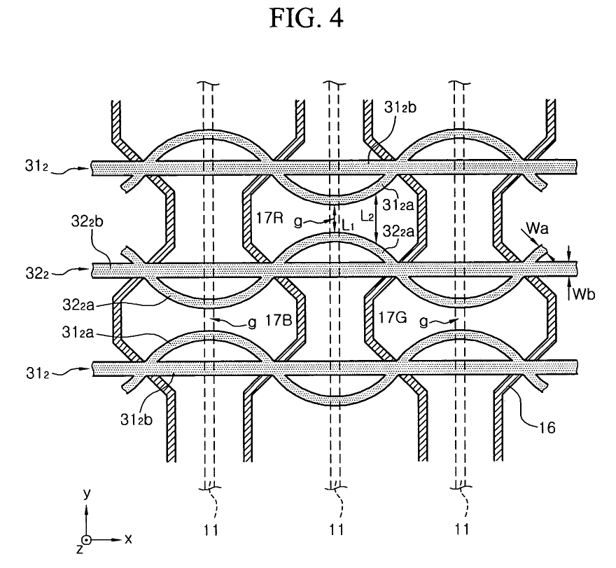

FIG. 4 illustrates a top plan view of a configuration and arrangement of barrier ribs and electrodes of a plasma display panel according to a second exemplary embodiment of the present invention. In overall configuration and effect, the second exemplary embodiment is analogous to the first exemplary embodiment, and therefore, features differing from the first exemplary embodiment are explained and compared with the first exemplary embodiment, while omitting repetition of the analogous features.

Compared with the first exemplary embodiment, the second exemplary embodiment may include further line portions 31₂b and 32₂b at the sustain electrodes 31₂ and the scan electrodes 32₂. That is, according to the second exemplary embodiment, each of the sustain electrodes 31₂ and the scan electrodes 32₂ may have arc portions 31₂a and 32₂a protruding toward the centers of the discharge spaces 17 and line portions 31₂b and 32₂b connecting the arc portions 31₂a and 32₂a in the second direction.

The line portions 31₂b and 32₂b may apply a stabilized signal voltage to the arc portions 31₂a and 32₂a, allowing a width Wa of the arc portions 31₂a and 32₂a to be narrow. Accordingly, a width Wb of the line portions 31₂b and 32₂b may be wider than the width Wa of the arc portions 31₂a and 32₂a. Moreover, the line portions 31₂b and 32₂b may be formed of the same material as the arc portions 31₂a and 32₂a, e.g., metal, thereby simplifying manufacturing. The line portions 31₂b and 32₂b may also be formed as one body with the arc portions 31₂a and 32₂a, respectively.

In accordance with embodiments of the present invention, barrier ribs have alternating wider and narrower portions in a first direction, discharge spaces being in the wider portions, and electrode pairs extend in a second direction, orthogonal to the first direction, protruding into the wider portions, i.e., the discharge spaces, forming discharge gaps. Thus, the discharge gap at a center of each discharge space may be short enough to induce initial discharge with a decreased discharge firing voltage, while the gap distance between the electrode pairs at a periphery of the discharge space is large enough to improve luminous efficiency.

Exemplary embodiments of the present invention have been disclosed herein, and although specific terms are employed, they are used and are to be interpreted in a generic and descriptive sense only and not for purpose of limitation. For example, while the band-shaped electrodes are illustrated as a sinusoid, any appropriate continuous pattern allowing the separation of the electrodes to be varied. Further, while the shape of the discharge cells is shown as angular, any alternating shape may be employed. Accordingly, it will be understood by those of ordinary skill in the art that various changes in form and details may be made without departing from the spirit and scope of the present invention as set forth in the following claims.

What is claimed is:

1. A plasma display panel, comprising:
a first substrate and a second substrate arranged opposing each other;
band-shaped metallic first and second electrodes disposed between the first and second substrates;
third electrodes disposed between the first and second substrates while extending in a first direction;
barrier ribs disposed between the first and second substrates, the barrier ribs being spaced apart from each other in a second direction intersecting the first direction to define column spaces that extend in the first direction, the column spaces having wider portions and narrower portions alternately, the wider portions corresponding to discharge spaces; and
a phosphor in the discharge spaces, wherein the first and second electrodes cross the barrier ribs and protrude inside the discharge spaces such that the first and second electrodes form discharge gaps in each discharge space.

2. The plasma display panel as claimed in claim 1, wherein the first electrodes and the second electrodes extend in the second direction and have bending portions protruding in the first direction in each of the discharge spaces.

3. The plasma display panel as claimed in claim 1, wherein the first electrodes and the second electrodes have arc portions protruding in the first direction toward centers of the discharge spaces.

4. The plasma display panel as claimed in claim 1, wherein the first electrodes and the second electrodes are arranged alternately along the first direction.

5. The plasma display panel as claimed in claim 1, wherein a distance between the first and second electrodes increases as a distance from a center of the discharge space approaches a periphery of the discharge space.

6. The plasma display panel as claimed in claim 1, wherein the discharge gaps formed by the first electrodes and the second electrodes form a row that intersects a column formed by the column spaces.

7. The plasma display panel as claimed in claim 1, wherein each of the first and second electrodes has arc portions protruding toward the centers of the discharge spaces and line portions connecting the arc portions in the second direction.

8. The plasma display panel as claimed in claim 7, wherein the line portions is wider than the arc portions.

9. The plasma display panel as claimed in claim 7, wherein the line portions are metal.

10. The plasma display panel as claimed in claim 1, wherein a pixel includes three adjacent discharge spaces, at least two of the three adjacent discharge spaces having centers shifted from one another in the first direction.

11. The plasma display panel as claimed in claim 10, wherein centers of the three adjacent discharge spaces form a triangle.

12. The plasma display panel as claimed in claim 1, wherein the first electrodes and the second electrodes extend in the second direction and have a sinusoidal pattern.

13. The plasma display panel as claimed in claim 1, wherein adjacent wider portions in the second direction correspond to every other third electrode.
